(19) United States
(12) Patent Application Publication
(10) Pub. No.: US 2015/0114606 A1
(43) Pub. Date: Apr. 30, 2015

(54) Capillary Action Heat Exchanger

(71) Applicant: Louisiana Tech University Research Foundation; a Division of Louisiana Tech University Foundation,, Ruston, LA (US)

(72) Inventor: Leland Weiss, Ruston, LA (US)

(21) Appl. No.: 14/525,882

(22) Filed: Oct. 28, 2014

Related U.S. Application Data
(60) Provisional application No. 61/896,893, filed on Oct. 29, 2013.

(51) Int. Cl. F28D 15/04; B23P 15/26

(52) U.S. Cl. CPC F28D 15/04; B23P 15/26
USPC 165/104.26; 29/890.035; 165/104.21

(57) ABSTRACT

A heat exchanger which including a metal exchange surface having a plurality of upward extending walls forming channels between the walls. The channels are between about 5 and about 500 um in width and the walls are between about 50 and about 1000 um in height. At least one reservoir communicates with the channels and a refrigerant is position in the reservoir, the refrigerant having a boiling point of at least about 50° C. A cover is positioned above the exchange surface such that refrigerant is returned to the exchange surface.

### CROSS REFERENCE TO RELATED APPLICATION

This application claims the benefit under 35 USC 119(e) of U.S. provisional application Ser. No. 61/896,893 filed Oct. 29, 2013, which is incorporated by reference herein in its entirety.

### BACKGROUND OF INVENTION

The present invention relates to heat exchangers for application in small scale heat exchange applications. As one example, thermoelectric devices are increasingly used in the field of thermal energy scavenging. Such thermoelectric devices rely on heat exchange with the environment to produce electrical power. Thus, more efficient heat exchangers provide increased heat transfer and therefore increased operating efficiency for the thermoelectric device.

### SUMMARY OF SELECTED EMBODIMENTS OF THE INVENTION

One embodiment of the invention is a heat exchanger which includes a metal exchange surface having a plurality of upward extending walls forming channels between the walls. The channels are between about 5 and about 500 um in width and the walls are between about 50 and about 1000 um in height. At least one reservoir communicates with the channels and a refrigerant is position in the reservoir, the refrigerant having a boiling point of at least about 50° C. A cover is positioned above the exchange surface such that refrigerant is returned to the exchange surface.

### BRIEF DESCRIPTION OF THE DRAWINGS

FIG. 1 is a side sectional view of one embodiment of a thermal energy generation heat transfer system of the present invention.

FIG. 2 is a perspective view of one embodiment of a micro-heat exchanger of the present invention.

FIG. 3A is an end sectional view of the heat exchanger embodiment of FIG. 2.

FIG. 3B is a perspective view of the underside of one embodiment of a heat exchanger cover.

FIG. 4 is a top planar view of another embodiment of a micro-heat exchanger of the present invention.

FIG. 5 is a side sectional view of a heat exchanger with an alternative cover.

### DETAILED DESCRIPTION OF SELECTED EMBODIMENTS OF THE INVENTION

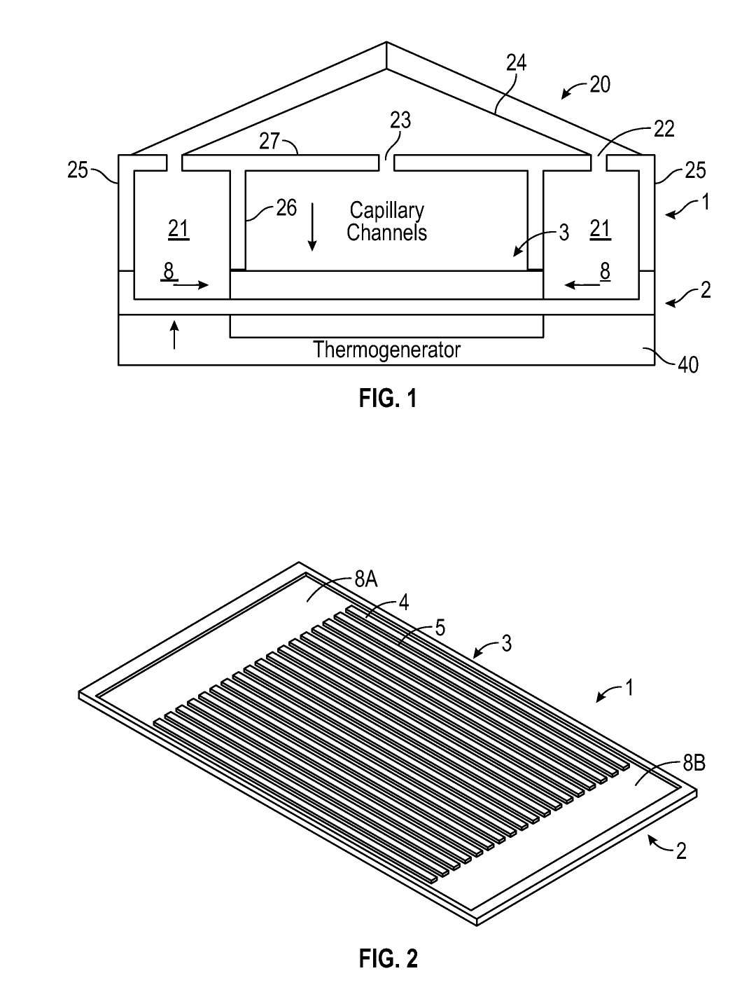

One embodiment of the present invention is the energy generation system suggested by the side sectional view of FIG. 1 and generally comprising a thermoelectric generator 40 and a heat exchanger 1. The thermoelectric generator 40 may include any number of conventional or future developed thermoelectric generators. As one nonlimiting example, thermoelectric generator 40 may be of the type employing semiconductor p-n junctions made from bismuth telluride (Bi₂Te₃), lead telluride (PbTe), calcium manganese oxide, or combinations thereof, depending on the expected operating temperature. Other non-limiting examples of generators may include thermoelectric materials such as micro and nano material enhancements currently in development. These include materials with specifically incorporated nano-inclusions or materials like metallics, graphitics, or materials such as incorporated nanowires with nonlimiting examples including indium, antimonide, or silicon nanowires for phonon scattering for increased operating efficiency. Thermoelectric generators generally work under the principle of a heat source being applied to one side and the opposite side being exposed to some form of a heat sink, which in the illustrated embodiments, is formed by heat exchanger 1. Other power generation devices may be used as non-limiting alternatives to a thermoelectric generator 40. These include micro-mechanical systems like micro-steam or micro-mechanical embodiments for mechanical or electrical based power output.

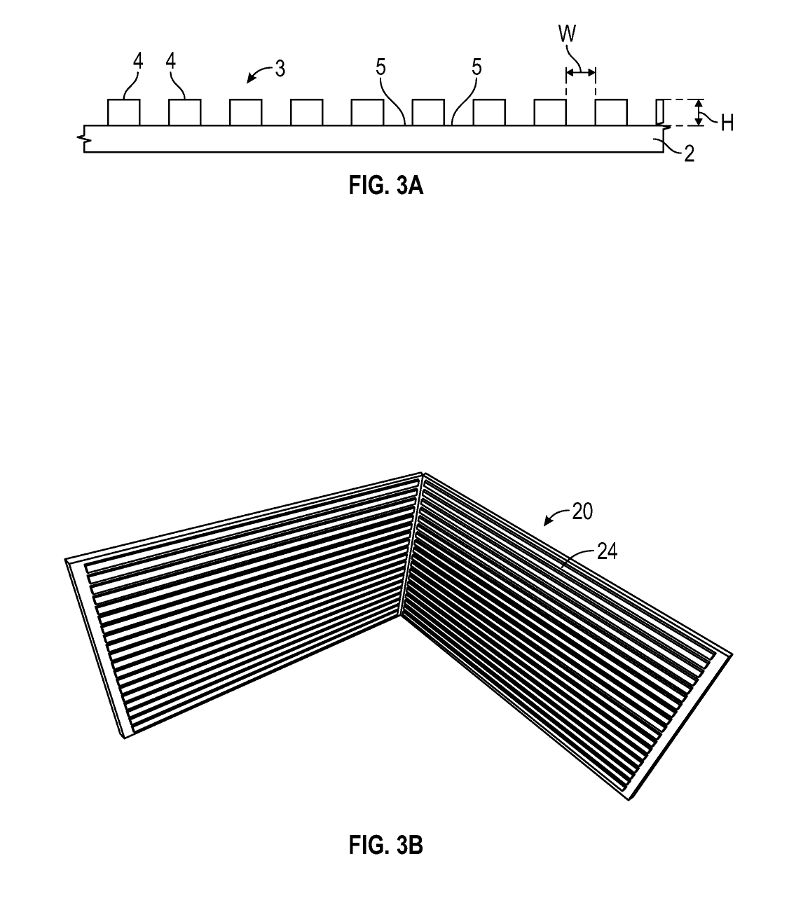

The heat exchanger 1 embodiment seen in FIG. 1 generally comprises the heat exchanger body 2, with exchange surface 3, and an exchanger cover 20. As better seen in the perspective view of FIG. 2 and the end sectional view of FIG. 3A, this embodiment of exchanger body 2 generally includes a plurality of upwardly extending walls 4 with channels 5 formed between the walls 4. In preferred embodiments, the walls 4 will have a height (“H”) of between about 50 um and 1000 um (i.e., any height or subrange of heights between 50 um and 1000 um), but other embodiments may have wall heights less than 50 um or more than 1000 um. In many embodiments, the preferred channel width (“W”) is between 100 um and 500 um which increases capillary force but maintains reduced thermal mass. Similarly, certain embodiments of channels 5 will have a width of between 5 um and 500 um (i.e., any width or subrange of widths between 5 um and 500 um), but other embodiments may have channel widths of less than 5 um or more than 500 um. Preferred channel widths are selected based, at least in part, on exchanger working fluid (e.g., refrigerant) surface tension i.e. reduced surface tension fluids are better suited for reduced widths. One non-limiting example is HCFC class refrigerants with low surface tension. Other non-limiting examples with low surface tension are alcohols like ethanol. Pentanes, Hexanes, and similar fluids with nano-particle thermal enhancements are other examples with low surface tension. Nano-particle inclusions may consist of materials like graphite nano-spheres or other materials including gold, copper oxides, or silica nanoparticles with some example concentrations ranging from about 0.5 to about 4% by volume. These refrigerants may be better suited for channel sizes of 5 um or less. Increased surface tension working fluids like water will prefer channel sizes of 500 um or greater. Because of certain sub-millimeter dimensions described in this embodiment, heat exchanger 1 may sometimes be referred to as a “micro-heat exchanger.” However, other embodiments may include devices not necessarily considered “micro-” devices.

In many embodiments, the surfaces of walls 4 and channels 5 will be formed of or covered with a metal and thereby form a metal exchange surface as described herein. The particular metal of the exchange surface could be any number of elemental metals or alloys thereof. Nonlimiting examples include Ni, Al, Cu, Au, Ag, Si, Pt, and Sn, whether in their elemental form or combined with other materials to form alloys. Examples of useful alloys for high temperature applications are nickel-based alloys like Inconol. In certain embodiments, it is preferred that the metal have a thermal conductivity of at least about 50 W/mK. In other embodiment, the metal comprises a thermal conductivity of between about 50 and about 400 W/mK. In still further embodiments, the metal may have a thermal conductivity of less than 50 or more than 400 W/mK.

The present invention is not limited to any particular manner of forming the metal exchange surface 3. For example, in some embodiments, the walls 4 and channels 5 may be formed by micro-machining into a mass of the chosen metal. In other embodiments, the metal exchange surface may be formed by electrodepositing the chosen metal onto a template or base. For example, in one preferred embodiment, a template of the walls 4 and channels 5 may be formed of a photoresist in a conventional lithography process. Then the metal chosen is electrodeposited onto the photoresist template by any conventional or future developed electrodeposition process. In certain examples, the metal is deposited in a layer between 50 um and 400 um thick. After metal deposition, the photoresist may be dissolved using conventional techniques or left in place under the metal surface. Typically when electrodepositing a metal, the metal will possess a degree of microporosity. This porosity may be measured as the volume of micropores in the metal layer divided by the total volume of the metal layer. For example, many metals identified above will have a porosity based on deposition density of at least about 30% and often between about 40% and about 85% of base metal accepted density. In various embodiments, the porosity can be any percentage or sub-range of percentages between 5% and 90%. In addition to the walls 4 and channels 5, the FIG. 2 embodiment illustrates recessed areas or reservoirs 8 formed on or near the ends of the channels and walls. In FIG. 2, the reservoirs 8A and 8B are formed by a stepped down section of exchanger body 2. The purposes of reservoirs 8 are described in more detail below.

As suggested in FIG. 1, in certain embodiments a cover 20 will be positioned over the exchanger body 2. This example of cover 20 generally comprises outer sidewalls 25, inner sidewalls 26, horizontal wall 27, and cover capillary channels 24. Also see FIG. 3B illustrating two inclined sections of cover 20 and the channels 24 formed on the underside of these inclined sections. Returning to FIG. 1, the cover 20 will typically be sealed to exchanger body 2 in a vapor tight manner with an adhesive or other suitable means. It can be seen that a reservoir space 21 is formed between sidewalls 25 and 26 and that reservoir space 21 is intended to form a continuous volume with the reservoir 8 in exchange body 2. This reservoir space is substantially enclosed by horizontal wall 27 except for the fluid inlets 22 communicating through horizontal wall 27. In a similar manner, inner sidewalls 26 together with horizontal wall 27 substantially enclose the volume above exchange surface 3, except for the vapor outlet 23 communicating through horizontal wall 27. Enclosing a volume above horizontal wall 27 are cover capillary channels 24. Cover capillary channels 24 may be of substantially similar construction and dimensions as wall 4 and channels 5. It will be understood that cover capillary channels 24 form a substantially pressure tight seal with the other components of cover 20 such that vapor passing through outlet 23 does not escape the heat exchanger system.

In operation, a refrigerant in a liquid phase will at least partially fill the reservoir space 8/21. Capillary action between the channels 5 and the refrigerant, plus absorption of refrigerant on the porous metal surface (when the exchange surface is metalized), will draw refrigerant across the exchange surface 3. Heat, conducting through exchanger base 2 and into the channels 5 and walls 4, will cause the refrigerant to boil or evaporate into the vapor phase. Refrigerant in the vapor phase will pass through vapor outlet 23 and eventually come into contact with cover capillary channels 24, which are intended to be maintained at a temperature below the condensing point of the refrigerant. Often the temperature of capillary channels 24 are maintained below the condensing point of the refrigerant by positioning capillary channels 24 to be exposed to a cooler environment. However, more active cooling systems may also be employed.

As the refrigerant condenses in capillary channels 24, the incline orientation of channels 24 will direct the liquid phase refrigerant toward fluid inlets 22 and thus back into reservoirs 8/21. Thus, it can be seen how cover 20 positioned above the exchange surface forms a refrigerant return path to the reservoirs. Naturally, many variations of this refrigerant return path is contemplated by the present invention. Fox example, cover capillary channels 24 need not be inclined in all embodiments, but could be parallel to horizontal wall 27. Nor do capillary channels 24 need to be metalized in all embodiments. Vertical cover and cover capillary channels 24 may be utilized in a parallel arrangement as suggested in FIGS. 5A and 5B. Nor is it necessary in all embodiments that condensed refrigerant be returned to the reservoir area. In some embodiments, the evaporated refrigerant may condense in capillary channels in a cover 20 and then directly fall back onto the exchange surface when the condensed refrigerant droplets become sufficiently large.

Many different types of conventional and future developed refrigerants may be used. In many embodiments, the refrigerants have boiling points between about 50° C. and about 100° C., for example NOVEC 7200 (boiling point of 76° C.); available from 3M Corporation of St. Paul, Minn. In other embodiments, the refrigerant may have a boiling point between about 25° C. and about 500° C. (or any subrange therebetween).

Although dependent on channel dimensions, channel surface material, and refrigerant properties, many embodiments of the heat exchanger will have a capillary rise height of one quarter to one inches when positioned vertically. “Capillary rise height” is the final height above the working fluid reservoir achieved by liquid present in microchannels due to surface tension forces within the microchannel when oriented vertically. Fluid wetting will fully cover capillary channels in horizontal configurations. Likewise, certain embodiments of the heat exchanger will have an effective power consumption (i.e., power moved across the heat exchanger) of at least about 2.2 kW/m². In many instances, metal-based heat exchangers will outperform certain non-metal embodiments where the particular application involves increased temperature response and working fluid evaporation or boiling points due to reduced exchanger thermal capacitance and increased thermal conductivity.

Since the movement of refrigerant is, in many embodiments, primarily through capillary forces and absorption forces, the orientation of the heat exchanger while in operation is not particularly relevant. For example, if the direction along the length of channels seen in FIG. 2 is considered the “long axis” of the exchange surface, then the exchange surface may be positioned such that this long axis is oriented nonparallel with the gravitational direction of force (i.e., downward in the direction which gravity acts on objects). This orientation may be such that the long axis of the exchange surface (or the channels 5) is perpendicular to the gravitational direction of force or any angle between perpendicular to and parallel to this long axis.

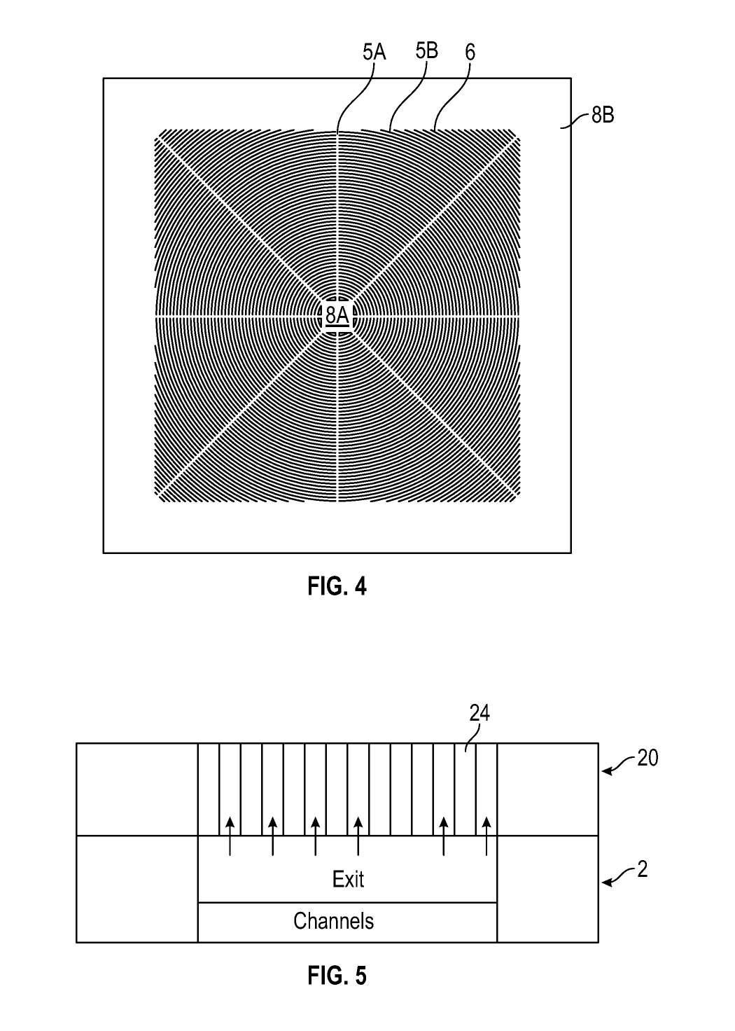

FIG. 4 illustrates one alternative exchange base 2 embodiment. In this embodiment, the exchange surface 3 is formed by a first series of channels 5A extending radially from a central reservoir 8A to the four sided perimeter reservoir 8B. A second series of concentric channels 5B and concentric walls 6 also extend outward from center reservoir 8A. The channels 5 and walls 6 may be metalized as described above. Although not illustrated, a cover similar to that seen in FIG. 1 may be positioned over the FIG. 4 exchange surface. Alternatively, the exchange surface of FIG. 4 could form the cover for the FIG. 1 embodiment.

FIG. 5 shows a comparatively simplified version of heat exchanger 1. The exchanger body 2 is similar to that discussed in connection with FIG. 1. However, the cover 20 has been simplified by having a series of vertical channels 24 formed therein. Since the cover channels 24 vertical, condensing refrigerant will tend to directly return to the channels in exchanger body 2.

Another embodiment of the present invention is a method of constructing a heat exchanger. Generally this method begins with providing an exchange template which may have a wall and channel structure similar to that describe above, i.e., channels having a width between about 5 and about 500 um, and walls being between about 50 and about 1000 um in height. A metal or alloy such as described above may be electrodeposited onto the surface of the exchange template to form a metal exchange surface. The metalized exchange surface is then connected to a reservoir in a manner allowing the reservoir to communicate with the channels. A refrigerant such as described above is positioned in the reservoir and a cover is positioned over the exchange surface in a manner to form a refrigerant return path to the reservoir.

Although certain specific embodiments of the invention have been described above, those skilled in the art will recognize many obvious modifications and variations. For example, while the above embodiments are described with covers, other embodiments may utilize exchange surfaces without covers together with an ongoing supply of refrigerant. All such modifications and variations are intended to come within the scope of the following claims.

1. A heat exchanger comprising:
a) a metal exchange surface having a plurality of upward extending walls forming channels between the walls;
b) the channels being between about 5 and about 500 um in width;
c) the walls being between about 50 and about 1000 um in height;
d) at least one reservoir communicating with the channels;
e) a refrigerant position in the reservoir, the refrigerant having a boiling point of at least about 50° C.;
f) a cover positioned above the exchange surface such that refrigerant is returned to the exchange surface.

2. The heat exchanger of claim 1, wherein the metal forming the exchange surfaces comprises a thermal conductivity of at least about 50 W/mK.

3. The heat exchanger of claim 2, wherein the metal forming the exchange surfaces comprises a thermal conductivity of at least about 90 W/mK.

4. The heat exchanger of claim 2, wherein the metal comprises a thermal conductivity of less about 400 W/mK.

5. The heat exchanger of claim 2, wherein the metal is an elemental metal or an alloy of the group consisting of Ni, Al, Cu, Au, Ag, Si, Pt, and Sn.

6. The heat exchanger of claim 4, wherein the metal is an elemental metal or an alloy of the group consisting of Ni, Al, and Cu.

7. The heat exchanger of claim 1, wherein the metal has a porosity of at least about 20%.

8. The heat exchanger of claim 1, wherein the metal has a porosity of between about 40% and about 85%.

9. The heat exchanger of claim 1, wherein the exchange surface has an effective power consumption of at least about 2.2 kW/m2.

10. The heat exchanger of claim 1, wherein the metal has a thickness of at least about 50 um.

11. The heat exchanger of claim 1, wherein the cover includes a series of internal channels onto which the refrigerant condenses, the channels being between about 5 and about 500 um in width, and the walls being between about 50 and about 1000 um in height.

12. The heat exchanger of claim 11, wherein the channels are less than about 100 um in width, and the walls are at least about 100 um in height.

13. The heat exchanger of claim 1, wherein the metal of the exchange surface is sufficiently porous to cause refrigerant transport by way of absorption and the channels are also sufficiently narrow to cause refrigerant transport by way of capillary action.

14. The heat exchanger of claim 1, wherein the refrigerant has a boiling point between about 50° C. and about 150° C.

15. The heat exchanger of claim 1, wherein the refrigerant acting on the metal of the exchange surface has a capillary rise height of 0.25 to 1 inches.

16. The heat exchanger of claim 1, wherein the channels have a long axis and the exchange surface is positioned such that the long axis is oriented nonparallel with a gravitational direction of force.

17. The heat exchanger of claim 16, wherein the long axis of the channels are oriented substantially perpendicular to the gravitational direction of force.

18. The heat exchanger of claim 1, wherein the cover includes capillary channels which are vertically or inclined at angles from the exchange surface.

19-20. (canceled)

21. A method of constructing a heat exchanger comprising the steps of:
a) forming a metal exchange surface comprising (i) a plurality of upward extending walls forming channels between the walls, (ii) the channels having a width between about 5 and about 500 um, and (iii) the walls being between about 50 and about 1000 um in height;
b) operatively connecting to the exchange surface at least one reservoir communicating with the channels;
c) positioning a refrigerant in the reservoir, the refrigerant having a boiling point of at least about 50° C.; and;
d) positioning a cover over the exchange surface in a manner to form a refrigerant return path to the reservoir.

22-25. (canceled)

26. A method of constructing a heat exchanger comprising the steps of:
a) providing an exchange template comprising (i) a plurality of upward extending walls forming channels between the walls, (ii) the channels having a width between about 5 and about 500 um, and (iii) the walls being between about 50 and about 1000 um in height;
b) electrodepositing a metal onto the surface of the exchange template to form a metal exchange surface;
c) operatively connecting to the metal exchange surface at least one reservoir communicating with the channels;
d) positioning a refrigerant in the reservoir, the refrigerant having a boiling point of at least about 50° C.; and;
e) positioning a cover over the exchange surface in a manner to form a refrigerant return path to the reservoir.

27-31. (canceled)
